(19) United States
(12) Patent Application Publication
(10) Pub. No.: US 2015/0113208 A1
(43) Pub. Date: Apr. 23, 2015

(54) STORAGE APPARATUS, CACHE CONTROLLER, AND METHOD FOR WRITING DATA TO NONVOLATILE STORAGE MEDIUM

(71) Applicant: KABUSHIKI KAISHA TOSHIBA, MINATO-KU (JP)

(72) Inventors: Itaru KAKIKI, YOKOHAMA-SHI (JP); MASATOSHI AOKI, YOKOHAMA-SHI (JP); FUMITOSHI HIDAKA, YOKOHAMA-SHI (JP); KAORI NAKAO, TOKYO (JP); TOMOKI YOKOYAMA, FUJISAWA-SHI (JP)

(73) Assignee: KABUSHIKI KAISHA TOSHIBA, MINATO-KU (JP)

(21) Appl. No.: 14/163,101

(22) Filed: Jan. 24, 2014

(30) Foreign Application Priority Data
Oct. 23, 2013 (JP) 2013-220317

(51) Int. Cl. G06F 12/02; G06F 12/08

(52) U.S. Cl. CPC G06F 12/0246; G06F 12/0802
USPC 711/103

(57) ABSTRACT

According to one embodiment, a storage apparatus includes a first storage medium which is nonvolatile, a second storage medium which is nonvolatile, a cache controller, and a main controller. An access speed of the second storage medium is lower, and a storage capacity of the second storage medium is larger than the first storage medium. The main controller controls the cache controller and accesses the second storage medium based on an access request from a host apparatus. The cache controller writes, in a multiplexed manner, data to be stored in the first storage medium to at least two areas in which deterioration of storage performance has been detected based on a result of access to the first storage medium.

### CROSS-REFERENCE TO RELATED APPLICATIONS

This application is based upon and claims the benefit of priority from Japanese Patent Application No. 2013-220317, filed Oct. 23, 2013, the entire contents of which are incorporated herein by reference.

### FIELD

Embodiments described herein relate generally to a storage apparatus, cache controller, and method for writing data to a nonvolatile storage medium.

### BACKGROUND

In recent years, storage apparatuses provided with a plurality of types (for example, two types) of nonvolatile storage media different from each other in access speed and storage capacity have been developed. As a representative of such storage apparatuses, a hybrid drive is known. In general, a hybrid drive is provided with a first nonvolatile storage medium, and second nonvolatile storage medium lower in access speed, and larger in storage capacity than the first nonvolatile storage medium.

As the first nonvolatile storage medium, a semiconductor memory such as a NAND flash memory is used. The NAND flash memory is known as a nonvolatile storage medium although high in unit price per unit capacity, capable of being accessed at high speed. As the second nonvolatile storage medium, a disk medium such as a magnetic disk is used. The disk medium is known as a nonvolatile storage medium although low in access speed, low in unit price per unit capacity. Accordingly, in a hybrid drive, in general, a disk medium (more specifically, a disk drive including a disk medium) is used as main storage, and a NAND flash memory (more specifically, a NAND flash memory higher in access speed than the disk medium) is used as a cache. Thereby, the access speed of the entire hybrid drive is enhanced.

In such a hybrid drive, an area (storage area) of the NAND flash memory is accessed more frequently than an area of the disk medium. The area (more specifically, the storage performance of the area) of the NAND flash memory deteriorates depending on the frequency of access (more specifically, read/write of data) to the area. Accordingly, in the hybrid drive in which a NAND flash memory is used as a cache, the area of the NAND flash memory is liable to deteriorate.

In the prior art, an area of a NAND flash memory in which a read error has occurred because of deterioration is treated as an unusable area (a so-called bad area). Accordingly, when the number of bad areas increases, the substantial storage capacity of the NAND flash memory (cache) lowers. Then, the cache hit rate lowers, and the performance of the entire hybrid drive lowers.

### BRIEF DESCRIPTION OF THE DRAWINGS

FIG. 1 is a block diagram showing an exemplary configuration of a hybrid drive according to an embodiment;

FIG. 2 is a conceptual view showing an exemplary format of a storage area of a NAND memory shown in FIG. 1;

FIG. 3 is a conceptual view showing an exemplary format of a storage area of a RAM provided in a memory controller shown in FIG. 1;

FIG. 4 is a view showing an example of a data structure of a cache management table shown in FIG. 2;

FIG. 5 is a flowchart showing an exemplary procedure for write processing to be executed by the memory controller shown in FIG. 1; and

FIG. 6 is a flowchart showing an exemplary procedure for read processing to be executed by the memory controller shown in FIG. 1.

### DETAILED DESCRIPTION

Various embodiments will be described hereinafter with reference to the accompanying drawings.

In general, according to one embodiment, a storage apparatus comprises a first storage medium which is nonvolatile, a second storage medium which is nonvolatile, a cache controller, and a main controller. An access speed of the second storage medium is lower, and a storage capacity of the second storage medium is larger than the first storage medium. The main controller is configured to control the cache controller, and access the second storage medium based on an access request from a host apparatus. The cache controller is configured to write, in a multiplexed manner, data to be stored in the first storage medium to at least two areas in which deterioration of storage performance has been detected based on a result of access to the first storage medium.

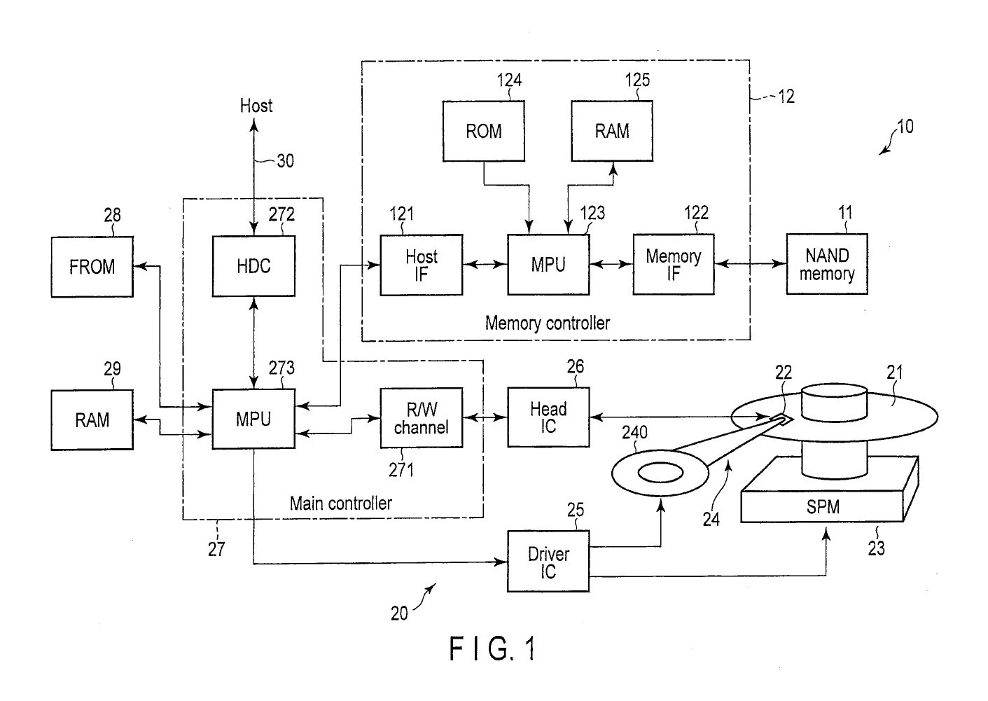

FIG. 1 is a block diagram showing an exemplary configuration of a hybrid drive according to an embodiment. The hybrid drive is provided with a plurality of types, for example, two types of nonvolatile storage media (that is, the first nonvolatile storage medium, and second nonvolatile storage medium) different from each other in access speed, and storage capacity. In the embodiment, as the first nonvolatile storage medium, a NAND flash memory (hereinafter referred to as a NAND memory) 11 is used, and as the second nonvolatile storage medium, a magnetic disk medium (hereinafter referred to as a disk) 21 is used. The access speed of the disk 21 is lower, and the storage capacity thereof is larger than the NAND memory 11.

The hybrid drive shown in FIG. 1 is constituted of a semiconductor drive unit 10 such as a solid-state drive, and hard disk drive unit (hereinafter referred to as an HDD) 20. The semiconductor drive unit 10 includes the NAND memory 11, and a memory controller 12.

The memory controller 12 controls access to the NAND memory 11 in response to an access request (for example, a write request or a read request) from a main controller 27. In the embodiment, the NAND memory 11 is used as a cache (cache memory) used to store data recently accessed by a host apparatus (hereinafter referred to as a host) for the purpose of enhancing the speed of access from the host to the hybrid drive. The host utilizes the hybrid drive shown in FIG. 1 as its own storage apparatus.

The memory controller 12 includes a host interface controller (hereinafter referred to as a host IF) 121, memory interface controller (hereinafter referred to as a memory IF) 122, microprocessor unit (MPU) 123, read-only memory (ROM) 124, and random access memory (RAM) 125. The host IF (first interface controller) 121 is connected to the main controller 27. The host IF 121 receives a signal transferred thereto from the main controller 27 (more specifically, an MPU 273 of the main controller 27), and transmits a signal to the main controller 27. Specifically, the host IF 121 receives a command (write command, read command, and the like) transferred thereto from the main controller 27, and delivers the received command to the MPU 123. The host IF 121 also returns a response from the MPU 123 to the command transferred from the main controller 27 to the main controller 27. The host IF 121 also controls data transfer between the main controller 27 and MPU 123.

The memory IF (second interface controller) 122 is connected to the NAND memory 11, and accesses the NAND memory 11 under the control of the MPU 123.

The MPU 123 executes processing (for example, write processing or read processing) for accessing the NAND memory 11 based on the command transferred from the main controller 27, in accordance with a first control program. In the embodiment, the first control program is stored in advance in the ROM 124. A rewritable nonvolatile ROM, for example, a flash ROM may be used in place of the ROM 124. A part of a storage area of the RAM 125 is used as a work area of the MPU 123. Another part of the storage area of the RAM 125 is used to store an access counter table 125a.

The HDD 20 includes a disk 21, head 22, spindle motor (SPM) 23, actuator 24, driver integrated circuit (IC) 25, head IC 26, main controller 27, flash ROM (FROM) 28, and RAM 29. The disk 21 is provided with a recording surface on which data is to be magnetically recorded on, for example, one surface thereof. The disk 21 is rotated at high speed by the SPM 23. The SPM 23 is driven by a drive current (or a drive voltage) supplied from the driver IC 25.

The disk 21 (more specifically, the recording surface of the disk 21) is provided with, a plurality of, for example, concentric tracks. The disk 21 may be provided with a plurality of tracks arranged in a spiral form. The head (head slider) 22 is arranged in association with the recording surface of the disk 21. The head 22 is attached to a distal end of a suspension extending from an arm of the actuator 24. The actuator 24 includes a voice-coil motor (VCM) 240 serving as a drive source of the actuator 24. The VCM 240 is driven by a drive current supplied from the driver IC 25. When the actuator 24 is driven by the VCM 240, this causes the head 22 to move over the disk 21 in the radial direction of the disk 21 so as to draw an arc.

In the configuration of FIG. 1, an HDD 20 provided with a single disk 21 is assumed. However, the HDD 20 may be an HDD provided with a plurality of disks 21. Further, in the configuration of FIG. 1, the disk 21 is provided with a recording surface on one surface thereof. However, the disk 21 may be provided with recording surfaces on both surfaces thereof, and heads may be arranged in association with both the recording surfaces.

The driver IC 25 drives the SPM 23, and VCM 240 in accordance with the control of the main controller 27 (more specifically, the MPU 273 in the main controller 27). The VCM 240 is driven by the driver IC 25, whereby the head 22 is positioned on a target track on the disk 21.

The head IC 26 is also referred to as a head amplifier. The head IC 26 is fixed, for example, to a predetermined location on the actuator 24 and electrically connected to the main controller 27 via a flexible printed circuit board (FPC). However, in FIG. 1, the head IC 26 is disposed away from the actuator 24, for convenience of drawing.

The head IC 26 amplifies a signal read by a read element in the head 22 (that is, a read signal). The head IC 26 also converts write data output by the main controller 27 (more specifically, an R/W channel 271 in the main controller 27) into a write current and outputs the write current to a write element in the head 22.

The main controller 27 is realized by, for example, a large-scale integrated circuit (LSI) in which a plurality of elements are integrated into a single chip. The main controller 27 includes a read/write (R/W) channel 271, hard disk controller (HDC) 272, and MPU 273.

The R/W channel 271 processes a signal associated with read/write. That is, the R/W channel 271 converts the read signal amplified by the head IC 26 into digital data, and decodes read data from the digital data. The R/W channel 271 also encodes write data transferred thereto from the HDC 272 through the MPU 273, and transfers the encoded write data to the head IC 26.

The HDC 272 is connected to the host through a host interface (storage interface) 30. The host and the hybrid drive shown in FIG. 1 are provided in an electronic device such as a personal computer, a video camera, a music player, a mobile terminal, a cellular phone, or a printer device.

The HDC 272 functions as a host interface controller configured to receive a signal transferred thereto from the host, and transfer a signal to the host. More specifically, the HDC 272 receives a command (write command, read command, and the like) transferred thereto from the host, and delivers the received command to the MPU 273. The HDC 272 also controls data transfer between the host and HDC 272. The HDC 272 further functions as a disk interface controller configured to control data write to the disk 21 and data read from the disk 21 through the MPU 273, R/W channel 271, head IC 26, and head 22.

The MPU 273 controls access to the NAND memory 11 through the memory controller 12, and access to the disk 21 through the R/W channel 271, head IC 26, and head 22 in accordance with an access request (a write request or a read request) from the host. This control is executed in accordance with a second control program. In the embodiment, the second control program is stored in the FROM 28. A part of the storage area of the RAM 29 is used as a work area of the MPU 273.

An initial program loader (IPL) may be stored in the FROM 28, and the second control program may be stored in the disk 21. In this case, it is sufficient if the second control program is loaded from the disk 21 into the FROM 28 or the RAM 29 by the MPU 273 executing the IPL when the power to the hybrid drive is turned on.

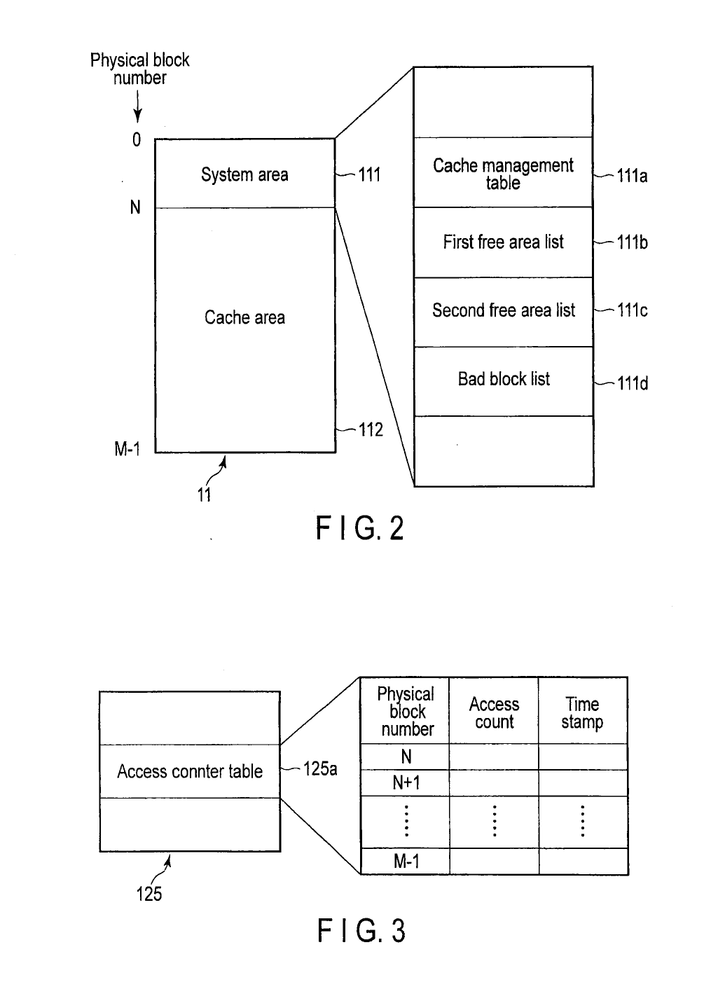

FIG. 2 is a conceptual view showing an exemplary format of a storage area of the NAND memory 11 shown in

FIG. 1. As shown in FIG. 2, the storage area of the NAND memory 11 is divided into a system area 111 and cache area 112. That is, the NAND memory 11 is provided with the system area 111 and cache area 112. The system area 111 is used to store information utilized by the system (for example, the memory controller 12) for management. The cache area 112 is used to store data recently accessed by the host. The storage area of the NAND memory 11 is constituted of M blocks (that is, physical blocks). In the NAND memory 11, data is collectively erased in units of blocks. That is, a block is a unit of data erasure.

The system area 111 is constituted of N physical blocks physical block numbers of which are 0 to N−1 (N<M). The cache area 112 is constituted of M−N physical blocks physical block numbers of which are N to M−1. In general, M−N is sufficiently greater than N.

A part of the system area 111 is used to store a cache management table 111a, first free area list 111b, second free area list 111c, and bad block list 111d. In the following description, the cache management table 111a is simply written as the table 111a in some cases. Further, the first free area list 111b, the second free area list 111c, and the bad block list 111d are simply written as the list 111b, list 111c, and list 111d, respectively in some cases.

As is generally known, in the NAND memory 11, it is not possible to overwrite an area in which data is already stored with new data (update data). Accordingly, the position of the table 111a in the system area 111 is changed each time the table 111a is updated. That is, the updated table (new table) 111a is written to an area different from the area in which the old table 111a has been stored. The same is true of the positions of the lists 111b, 111c, and 111d in the system area 111.

It is assumed that information about the positions and sizes of the table 111a, and lists 111b, 111c, and 111d in the system area 111 is stored in a first area of the RAM 125, and second area of the disk 21. In the embodiment, information stored in the second area of the disk 21 is read by the control of the MPU 273 when the power to the hybrid drive is turned on, and is loaded into the first area of the RAM 125 through the host IF 121, and MPU 123. When the position of the table 111a, lists 111b, 111c or 111d in the system area 111 is changed, the MPU 123 and MPU 273 update the corresponding position information in the first area of the RAM 125 and corresponding position information in the second area of the disk 21, respectively.

The cache management table 111a is used to store block management information for managing each of the blocks in the cache area 112 of the NAND memory 11. In the embodiment, the block management information is used as cache directory information about an address (storage position) of data stored in each of the blocks (areas of a predetermined size) in the cache area 112. The cache directory information includes information for managing correspondence between the physical address of the data, and logical address of the data. The physical address (here, the physical block number) of the data is indicative of a position of a block (area) in the NAND memory 11 in which the data is stored. The logical address (here, the logical block number) of the data is indicative of a position (storage position) of the data in the logical address space. The data structure of the cache management table 111a will be described later.

The first free area list 111b is used to register a free area of a first type in the cache area 112. That is, the first free area list 111b is used as first management information for managing a free area of the first type. The free area of the first type refers to a normal free area. The second free area list 111c is used to register a free area of a second type in the cache area 112. That is, the second free area list 111c is used as second management information for managing a free area of the second type. The free area of the second type refers to a free area in which a read error has occurred in the past. The bad block list 111d is used to register an unusable block (physical block), i.e., a bad block (area). That is, the bad block list 111d is used as third management information for managing a bad block.

FIG. 3 is a conceptual view showing an exemplary format of a storage area of the RAM 125 included in the memory controller 12 shown in FIG. 1. A part of the storage area of the RAM 125 is used to store the access counter table 125a. The access counter table 125a is used to store access count information of each of the M−N blocks of the cache area 112 in association with a physical block number of the block. The access count information includes an access count and time stamp.

The access count is indicative of the number of times of access to a block of a corresponding physical block number. An initial value of the access count is zero. The time stamp is indicative of, for example, the most recent time at which a block of a corresponding physical block number is accessed.

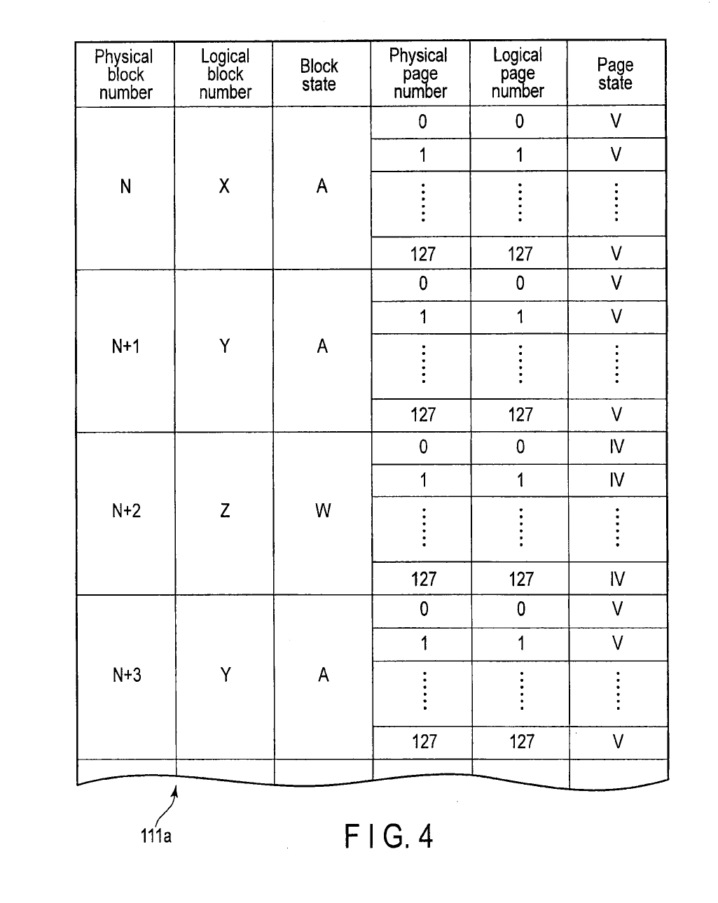

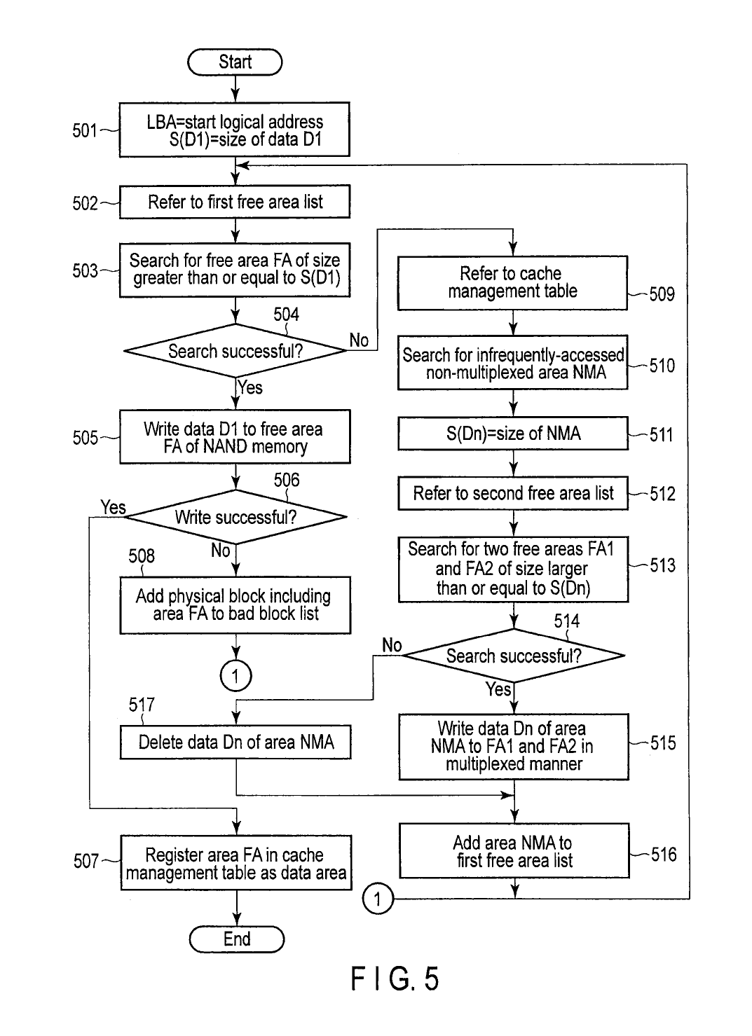

The access counter table 125a is read from the RAM 125 by the control of the MPU 123 when the power to the hybrid drive is turned off, and is transferred to the main controller 27. The MPU 273 of the main controller 27 saves the access counter table 125a in a third area of the disk 21. The access counter table 125a saved in the third area is read by the control of the MPU 273 when the power to the hybrid drive is turned on, and is loaded into the RAM 125 through the host IF 121, and MPU 123. FIG. 4 shows an example of a data structure of a cache management table 111a shown in FIG. 2. The cache management table 111a is used to store block management information of each of the M-N blocks of the cache area 112 in association with a physical block number of the block. The block management information includes a logical block number and block state information.

The logical block number is indicative of a logical block to which a block of a corresponding physical block number is assigned. The logical block refers to an area (logical area) obtained by dividing the logical address space recognized by the host using a size equal to the physical block. The block state information is indicative of a state of a block of a corresponding physical block number. In the embodiment, the block state indicated by the block state information is one of W, A, and B. Block state W is indicative of that data of a corresponding block is invalid. Block state A is indicative of that the number of times of access to a block of a corresponding physical block number is one. Block state B is indicative of that the number of times of access to a block of a corresponding physical block number is greater than or equal to two.

As described above, the block management information is information for managing a block of a corresponding physical block number. The block management information is indicative of the correspondence between a block of a corresponding physical block number, and logical block to which the block is assigned. Accordingly, it can be said that the block management information is also cache directory information for managing a storage position of data stored in a corresponding logical block in the NAND memory 11. Accordingly, in the following description, the block management information is called cache directory information in some cases.

It is assumed that each of the blocks of the cache area 112 is constituted of a plurality of pages, for example, 128 pages (physical pages). In this case, the logical block is also constituted of 128 pages (logical pages). In the embodiment, 1 block is constituted of 256 kilobytes (KB), and 1 page is constituted of 2 KB.

The cache management table 111a is further used to store page management information of each page in association with a physical block number of the block, and physical page number of each page for each of the M-N blocks of the cache area 112, and for each page of the block. That is, the block management information (cache directory information) includes page management information of each page of the corresponding block. The page management information includes the logical page number, and page state information.

The logical page number is indicative of a logical page (logical page in the logical block) to which a page (physical page) of a corresponding physical block number, and physical page number is assigned. That is, the logical page number is indicative of a position (storage position) in the logical address space of data stored in a corresponding physical page. Accordingly, the page management information is also used as cache directory information.

The page state information is indicative of a state of a corresponding physical page. The page state indicated by the page state information is one of IV and V. Page state IV is indicative of that data of a corresponding page is invalid. Page state V is indicative of that data of a corresponding page is valid.

Next, an operation of the hybrid drive of FIG. 1 will be described below with reference to FIG. 5 by taking a case where a write request (command) is issued from the host to the drive as an example. FIG. 5 is a flowchart showing an exemplary procedure for write processing to be executed by the memory controller 12 (more specifically, the MPU 123 of the memory controller 12) of the hybrid drive.

It is assumed that firstly the host has issued a first write request to the hybrid drive shown in FIG. 1 through the host interface 30. The first write request includes a start logical address, and size information indicative of a size of data (write data) D1 to be written. In the embodiment, the minimum unit of access from the host to the hybrid drive is 2 pages (that is, 4 KB). However, in the following, it is assumed for simplification of description that the host accesses the hybrid drive in units of blocks. It is assumed here that the start logical address is indicative of a stat position of a logical block X a logical block number of which is X, and the size of data D1 is the size (256 KB) of one block.

The HDC 272 of the main controller 27 in the hybrid drive shown in FIG. 1 receives the first write request (command) from the host. The HDC 272 also receives the write data D1 specified by the first write request from the host.

The received first write request is delivered to the MPU 273 of the main controller 27 by the HDC 272. Then, the MPU 273 sends a second write request and the write data D1 to the memory controller 12. The second write request includes, like the first write request, a start logical address, and size information indicative of a size of the write data D1. That is, the second write request corresponds to the received first write request.

The memory controller 12 functions as a cache controller in accordance with the second write request from the MPU 273. That is, the memory controller 12 controls the NAND memory 11 as a cache memory and thus executes the second write request.

First, the second write request is received by the host IF 121 of the memory controller 12, and is thereafter delivered to the MPU 123 of the memory controller 12 by the host IF 121. Then, the MPU 123 executes write processing (that is, cache write processing) for writing data D1 specified by the second write request to the cache area 112 of the NAND memory 11 by following the procedure shown by the flowchart of FIG. 5 in the manner described below.

First, the MPU 123 substitutes the start logical address for a parameter LBA, and substitutes the size of data D1 for a parameter S (D1) (block 501). Next, the MPU 123 refers to the first free area list 111b stored in the system area 111 of the NAND memory 11 (block 502). Further, the MPU 123 searches the first free area list 111b for a free area FA of a size greater than or equal to a value indicated by the parameter S (D1) (block 503).

In the embodiment, the value indicated by the parameter S (D1) is indicative of the size (256 KB) of one block. In this case, the MPU 123 searches for, for example, one free block as the free area FA. Further, the MPU 123 determines whether the MPU 123 has succeeded in the search of the free area FA (block 504).

When the search of the free area (block) FA has been successful (Yes in block 504), the MPU 123 controls the memory IF 122 and thus writes data D1 to the free area FA of the NAND memory 11 (block 505). In this case, the MPU 123 deletes information concerning the free area FA found from the first free area list 111b.

In the embodiment, the first free area list 111b is stored in the system area 111 of the NAND memory 11. Accordingly, the MPU 123 actually writes the new first free area list 111b from which the information concerning the found free area FA has been deleted as described above to a free area in the system area 111. Therefore, the free area in the system area 111 may also be managed by using the first free area list 111b. Further, a free area list for managing the free area in the system area 111 may be stored in the system area 111 separately from the first free area list 111b.

After executing the write (block 505) of data D1, the MPU 123 determines whether the MPU 123 has succeeded in the write of data D1 (block 506). It is assumed here that the write of data D1 has normally been completed, and hence the MPU 123 has succeeded in the write of data D1 (Yes in block 506). In this case, the MPU 123 registers block management information (that is, cache directory information) for managing the area FA as the data area of data D1 in the cache management table 111a (block 507). In block 507, the MPU 123 causes the host IF 121 to return a completion response (that is, a write completion response) to the second write request from the main controller 27 (MPU 273) to the main controller 27. After executing block 507, the MPU 123 terminates the write processing.

Upon reception of the completion response from the host IF 121 of the memory controller 12, the MPU 273 of the main controller 27 causes the HDC 272 to return a completion response to the first write request from the host to the host. This completion response is returned to the host without waiting for completion of, for example, disk write processing (to be described later) based on the first write request.

Here, the registration operation in block 507 will be specifically described below by taking the case where the free area FA is a block N a physical block number of which is N as an example. First, the MPU 123 extracts a logical block number from a start logical address indicated by the parameter LBA. In the embodiment, a logical block number is indicated by a predetermined upper address (for example, an upper address excluding lower 18 bits of the logical address) of the logical address. In the above-mentioned example of the start logical address, X is extracted as the logical block number.

Then, the MPU 123 registers logical block number X, and block state information (more specifically, block state information indicative of block state A) in the cache management table 111a in association with physical block number N. Further, the MPU 123 registers logical page numbers 0 to 127, and page state information (more specifically, page state information indicative of page state V) in the cache management table 111a in association with each of physical page numbers 0 to 127 associated with physical block number N.

In this way, the cache directory information concerning physical block N (more specifically, data D1 of logical block X stored in physical block N) is updated to the latest state in the cache management table 111a. At this time, if the cache directory information concerning the old data of logical block X is registered in the cache management table 111a, the cache directory information (that is, the old cache directory information) is invalidated.

The invalidation of the cache directory information is executed in the following manner. First, it is assumed that the old data of logical block X is stored in a physical block Y a physical block number of which is Y. That is, it is assumed that logical block number X is associated with physical block number Y by the old cache directory information (that is, block management information concerning physical block Y) concerning the old data of logical block X, and registered in the cache management table 111a. In this case, the MPU 123 updates the block state information of the old cache directory information from the information indicative of the state A or B to the information indicative of the state W.

In the embodiment, the cache management table 111a is stored in the system area 111 of the NAND memory 11. Accordingly, in block 507, actually the new cache management table 111a including the updated cache directory information is written to a free area in the system area 111. On the other hand, the old cache management table 111a is invalidated.

It is assumed that unlike the above-mentioned example, the size of data D1 is a size smaller than the size of one block, for example, the size (4 KB) of 2 pages. It is assumed that the logical page number of the beginning logical page (first logical page) of data D1 is X0, and the logical page number of the next logical page (second logical page) is X1 (X1=X0+1). The first logical page is a logical page in the logical block a logical block number of which is X, and logical page number X0 is indicated by a predetermined medium address (for example, 7 bits on the upper side of the lower 18 bits of the logical address) of the start logical address. That is, logical page number X0 is extracted from the start logical address.

Now, when the size of data D1 is the size of 2 pages, it is sufficient if the MPU 123 writes data D1 to two free pages (for example, pages 0 and 1) in the found free area FA (that is, a block N a physical block number of which is N). In this case, the MPU 123 registers each of logical page numbers X0 and X1 paired page state information (more specifically, page state information indicative of page state V) in the cache management table 111a in association, respectively with, physical page numbers 0 and 1 associated with physical block number N. When the size of data D1 is the size of 2 pages, the MPU 123 may search for at least two free pages as the free area FA.

Now, in block 507, the MPU 123 updates the access counter table 125a stored in the RAM 125. In the above-mentioned example, the MPU 123 updates the access count information stored in the access counter table 125a in association with physical block number N. That is, the MPU 123 increments the access count of the access count information associated with physical block number N by one, and sets a time stamp indicative of the current time to the access count information.

Next, the case where the write of the data to the free area FA is a failure (No in block 506) will be described below. In this case, the MPU 123 adds, for example, the physical block (physical block N in this case) including the area FA to the bad block list 111d as a bad block (block 508). That is, the MPU 123 adds information (for example, physical block number N of physical block N) indicative of physical block N to the bad block list 111d. Here, it is assumed that the size of the area FA is smaller than the size of one block, and data Dm of another area Am in the physical block including the area FA is stored in the NAND memory 11. In this case, in block 508, the MPU 123 invalidates the cache directory information concerning data Dm (address of data Dm), and registered in the cache management table 111a. This invalidation is equivalent to deletion of data Dm of the area Am. After executing block 508, the MPU 123 returns to block 502.

Next, the case where the search of the free area FA is a failure (No in block 504) will be described below. In this case, the MPU 123 executes the following processing (blocks 509 to 516) in order to secure a free area.

First, the MPU 123 refers to the cache management table 111a (more specifically, block state information in the cache management table 111a) (block 509). Further, the MPU 123 searches for an infrequently-accessed physical area (block) which is not multiplexed, i.e., an infrequently-accessed non-multiplexed area (block) NMA (block 510).

The infrequently-accessed physical area (block) refers to a physical area (block) the state (block state) of which is A, i.e., a physical area (block) which has been accessed only once. On the other hand, the non-multiplexed area (block) NMA refers to, when only one physical area (block) is assigned to one logical area (block), the assigned physical area (block). Conversely, when at least two physical areas (blocks) are assigned to one logical area (block), the at least two physical areas (blocks) are called a multiplexed area (block).

In the embodiment, it is assumed for simplification of description that an infrequently-accessed non-multiplexed block is found as the non-multiplexed area NMA. The search of the non-multiplexed block is executed in the following manner.

First, the MPU 123 searches the cache management table 111a for a set of a physical block number (hereinafter referred to as a first physical block number), and logical block number which are associated with block state A. Next, the MPU 123 searches for a second physical block number associated with the found logical block number, and different from the first physical block number. If the search of the second physical block number is a failure, the MPU 123 determines that the physical block indicated by the first physical block number is an infrequently-accessed non-multiplexed area NMA.

When a plurality of non-multiplexed areas NMA are associated with block state A, the MPU 123 may select a non-multiplexed area NMA which has been accessed at the earliest time. That is, the MPU 123 may select a non-multiplexed area NMA associated with a time stamp indicative of the earliest time from a plurality of non-multiplexed areas NMA associated with block state A, by referring to the access counter table 125a. Further, the MPU 123 may select the first-found non-multiplexed area NMA.

Next, a case where no non-multiplexed area NMA associated with block state A exists is assumed. In this case, the MPU 123 may select a non-multiplexed area NMA associated with a time stamp indicative of the earliest time from a plurality of non-multiplexed areas NMA associated with block state B. Further, the MPU 123 may select a non-multiplexed area NMA associated with the minimum access count from a plurality of non-multiplexed areas NMA associated with block state A, by referring to the access counter table 125a.

Next, the case where the search of the second physical block number is successful will be described below. In this case, the MPU 123 determines that the physical block indicated by the first physical block number is not a non-multiplexed area NMA. Then, the MPU 123 continues the search of the non-multiplexed area NMA.

It is assumed that the non-multiplexed area NMA has been found in the manner described above (block 510). In this case, the MPU 123 substitutes the size (256 KB in this case) of the non-multiplexed area NMA for the parameter S (Dn) (block 511). Next, the MPU 123 refers to the second free area list 111c (block 512). Further, the MPU 123 searches the second free area list 111c for two free areas FA1 and FA2 of a size larger than or equal to a value indicated by the parameter S (Dn) (block 513).

In the embodiment, the value indicated by the parameter S (Dn) is indicative of the size (256 KB) of one block. In this case, the MPU 123 searches for, for example, two free blocks as free areas FA1 and FA2. Further, the MPU 123 determines whether the search of free areas FA1 and FA2 has been successful (block 514).

If the search of free areas (blocks) FA1 and FA2 has been successful (Yes in block 514), the MPU 123 controls the memory IF 122 and thus writes data Dn to both free areas FA1 and FA2 of the NAND memory 11 (block 515). That is, the MPU 123 writes data Dn to free areas FA1 and FA2 in a multiplexed manner.

Further, in block 515, the MPU 123 deletes the information concerning the free areas FA1 and FA2 found from the second free area list 111c. Further, in block 515, the MPU 123 updates the cache directory information concerning data Dn, and registered in the cache management table 111a. Furthermore, in block 515, the MPU 123 updates the access count information stored in the access counter table 125a in association with a physical block number corresponding to free area FA1, and access count information stored in the access counter table 125a in association with a physical block number corresponding to free area FA2. Further, the MPU 123 adds the non-multiplexed area NMA to the first free area list 111b (block 516). Thereby, the number (that is, the storage capacity of free areas) of free areas increases.

In the embodiment in which the non-multiplexed area NMA is the non-multiplexed area block, the MPU 123 collectively deletes the data of the non-multiplexed area NMA when the non-multiplexed area NMA is registered in the first free area list 111b. Thereby, the non-multiplexed area NMA becomes utilizable as a free area. Conversely, it is assumed that the non-multiplexed area NMA is a partial area Aa in the physical block. In this case, if the remaining area Ab in the physical block has already been registered in the first free area list 111b, the MPU 123 collectively deletes the data of the physical block. On the other hand, if the area Ab in the physical block is not registered in the first free area list 111b, the MPU 123 waits for the area Ab to be registered in the first free area list 111b, and collectively deletes the data of the physical block.

After executing block 516, the MPU 123 returns to block 502. On the other hand, if the search of free areas FA1 and FA2 is a failure (No in block 514), the MPU 123 deletes data Dn of the non-multiplexed area NMA (block 517). More specifically, the MPU 123 invalidates the cache directory information concerning data Dn, and registered in the cache management table 111a. Further, the MPU 123 adds the non-multiplexed area NMA to the first free area list 111b (block 516), and thereafter returns to block 502.

Now, having sent the second write request corresponding to the first write request to the memory controller 12, the MPU 273 of the main controller 27 starts disk write processing based on the first write request. That is, the MPU 273 controls the driver IC 25 such that the head 22 is positioned on the target track on the disk 21 specified by the start logical address. Further, in the state where the head 22 is positioned on the target track, the MPU 273 causes the head 22 to write data D1 through the R/W channel 271, and head IC 26.

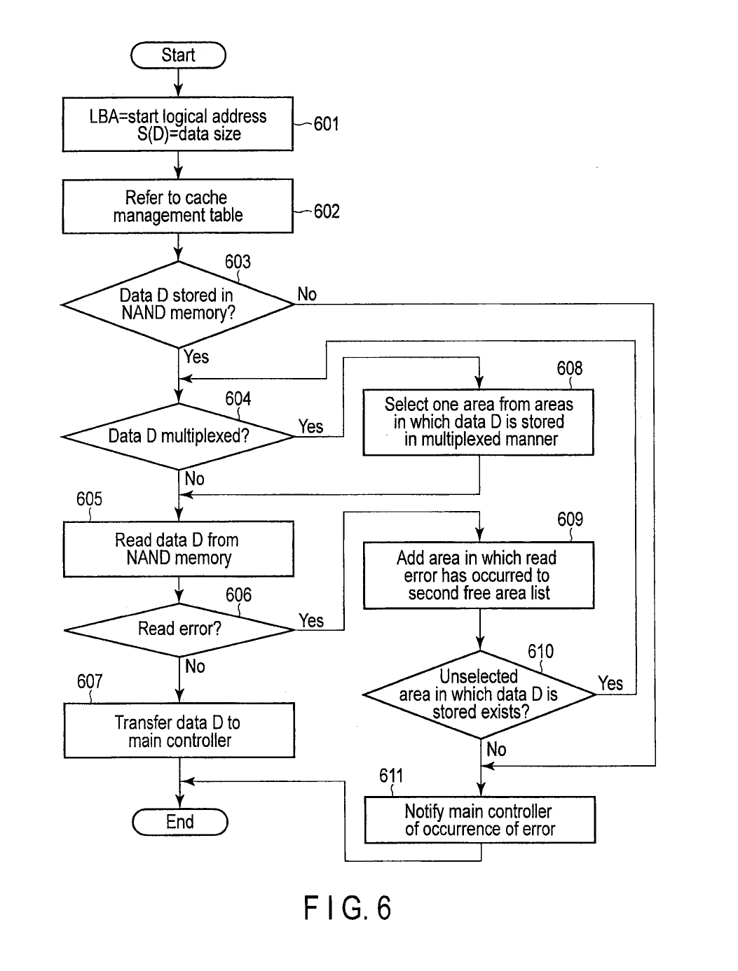

Next, an operation of the hybrid drive of FIG. 1 will be described below by taking the case where a read request (command) is issued from the host to the drive as an example with reference to FIG. 6. FIG. 6 is a flowchart showing an exemplary procedure for read processing to be executed by the memory controller 12 (more specifically, the MPU 123 of the memory controller 12) of the hybrid drive.

First, it is assumed that the host has issued a first read request to the hybrid drive shown in FIG. 1. The first read request includes a start logical address, and size information indicative of a size of data (read data) D to be read. Here, it is assumed that the start logical address is indicative of a start position of a logical block Y a logical block number of which is Y, and the size of the data D is a size of one block.

The first read request (command) from the host is received by the HDC 272 of the main controller 27, and is thereafter delivered to the MPU 273 by the HDC 272. Then, the MPU 273 sends a second read request to the memory controller 12. The second read request includes, like the first read request, a start logical address, and size information indicative of a size of the read data D. That is, the second read request corresponds to the received first read request. The second read request sent out by the MPU 273 is received by the host IF 121 of the memory controller 12, and is thereafter delivered to the MPU 123 of the memory controller 12 by the host IF 121.

Then, the MPU 123 executes read processing (that is, cache read processing) for reading the data D specified by the second read request from the cache area 112 of the NAND memory 11 by following the procedure shown by the flowchart of FIG. 6 in the manner described below.

First, the MPU 123 substitutes the start logical address for a parameter LBA, and substitutes the size of the data D for a parameter S (D) (block 601). Next, the MPU 123 refers to the cache management table 111a based on a start logical address indicated by the parameter LBA (block 602). Details of block 602 are as follows.

First, the MPU 123 extracts a logical block number from a start logical address indicated by the parameter LBA. In the example of the above-mentioned start logical address, Y is extracted as the logical block number. The MPU 123 refers to the cache management table 111a based on the extracted logical block number Y. Further, the MPU 123 searches the cache management table 111a for valid cache directory information (that is, cache directory information indicative of block state A or B) including the extracted logical block number Y.

In the embodiment, the cache directory information is registered in the cache management table 111a in association with the physical block number. Accordingly, when the cache directory information is found based on the physical block number, high-speed search is enabled. Conversely, when the cache directory information is found based on the logical block number as described above, high-speed search is hardly achieved. Thus, an address translation table used to translate a logical block number (logical address) into a physical block number (physical address) may be stored in the system area 111. In the address translation table, address translation information indicative of a correspondence between the logical block number and physical block number is registered for each logical block. In this case, when the cache directory information is to be registered in the cache management table 111a, it is sufficient if the MPU 123 registers address translation information corresponding to the cache directory information in the address translation table.

Now, the MPU 123 executes the cache directory information search by referring to the cache management table 111a (block 602), and thereafter advances to block 603. In block 603, the MPU 123 determines whether the data D (that is, the data D specified by the second read request) is stored in the NAND memory 11 according to whether the objective cache directory information could have been found. In the case of a cache hit, that is, the case where the data D is stored in the NAND memory 11 (Yes in block 603), the MPU 123 advances to block 604.

In block 604, the MPU 123 determines whether the data D is multiplexed in the NAND memory 11. This determination is executed by the following procedure. First, the MPU 123 refers to the cache management table 111a based on the extracted logical block number Y. Further, the MPU 123 searches the cache management table 111a for valid cache directory information (hereinafter referred to as second cache directory information) including the extracted logical block number Y, and different from the cache directory information (hereinafter referred to as first cache directory information) found in block 602. The MPU 123 determines whether the data D is multiplexed according to whether the second cache directory information could have been found.

If the data D is not multiplexed (No in block 604), the MPU 123 advances to block 605. In block 605, the MPU 123 controls the memory IF 122 and thus reads the data D from a physical block indicated by the first cache directory information. The memory IF 122 notifies the MPU 123 whether an uncorrectable error (that is, a read error) has been detected in the read of the data D. Further, when no read error has been detected, the memory IF 122 transfers the normally-read data D to the MPU 123.

The MPU 123 determines whether a read error has occurred in the read of the data D based on the notification from the memory IF 122 (block 606). If no read error has occurred (No in block 606), the MPU 123 causes the host IF 121 to transfer the normally-read data D to the main controller 27 (MPU 273) (block 607). That is, the host IF 121 uses a completion response (that is, a read completion response) to the second read request from the main controller 27 and thus returns the data D to the main controller 27.

Further, in block 607, the MPU 123 updates the block state information of the first cache directory information in the cache management table 111a according to block state A or B indicated by the block state information. That is, when the block state information is indicative of block state A, the MPU 123 updates the block state information such that the block state information is indicative of block state B. Conversely, when the block state information is indicative of block state B, the MPU 123 deters update of the block state information. Thereby, it is possible to prevent the system area 111 from being deteriorated by frequent occurrence of update (that is, write) of the cache management table 111a in the system area 111 of the NAND memory 11.

Furthermore, in block 607, the MPU 123 updates the access counter table 125a. That is, the MPU 123 increments the access count associated with the physical block number in the first cache directory information in the access counter table 125a by one, and registers the time stamp indicative of the current time in association with the physical block number. Thereby, the MPU 123 terminates the read processing.

Upon reception of the read completion response from the host IF 121 of the memory controller 12, the MPU 273 of the main controller 27 causes the HDC 272 to transfer the data D to the host. That is, the HDC 272 uses the completion response to the first read request from the host and thus returns the data D to the host.

Next, the case where the data D is multiplexed (Yes in block 604) will be described below. In the example of the cache management table 111a shown in FIG. 4, the data D of logical block Y the logical block number of which is Y is stored, in a multiplexed manner, in physical block N+1 the physical block number of which is N+1, and physical block N+3 the physical block number of which is N+3. When the data D is multiplexed as described above (Yes in block 604), the MPU 123 advances to block 608. As is evident from the above description of the write processing, the physical blocks N+1, and N+3 are blocks found from the second free area list 111c, and used for multiplex write of the data D. That is, each of physical blocks N+1, and N+3 is a block registered in the second free area list 111c when a read error has occurred therein in the past, and thereafter used for multiplex write of the data D.

In block 608, the MPU 123 selects one area (for example, physical block N+1) from areas (here, physical blocks N+1, and N+3) which are in the NAND memory 11, and in which the data D is stored in a multiplexed manner. Then, the MPU 123 advances to block 605. In block 605, the MPU 123 reads the data D from the selected area (physical block N+1) in the NAND memory 11. The MPU 123 determines whether a read error has occurred in the read of the data D (block 606).

Next, the case where a read error has occurred in the read of the data D (Yes in block 606) will be described below. In this case, the MPU 123 adds the area (that is, the area storing therein the data D with which a read error has been detected) in which a read error has occurred to the second free area list 111c (block 609). Accordingly, when a read error has occurred in the read of the data D from physical block N+1 selected in block 608, physical block N+1 is added to the second free area list 111c again.

Next, the MPU 123 determines whether an unselected area in which the data D is stored exists (block 610). In the embodiment in which a read error has occurred in the read of the data D from physical block N+1, physical block N+3 exists as the unselected area (Yes in block 610). In this case, the MPU 123 returns to block 604. Further, the MPU 123 advances from block 604 to block 608 to thereby select physical block N+3, and thereafter reads the data D from physical block N+3 (block 605).

Each of physical blocks N+1 and N+3 is, as described previously, a blocks in which a read error has occurred in the past. In the prior art, such physical blocks N+1 and N+3 are registered in the bad block list 111d as bad blocks (that is, unusable blocks), and are not used for data storage. Conversely, in the embodiment, physical blocks N+1 and N+3 are registered in the second free area list 111c as blocks (multiplexed storage area) used for data multiplexing.

Therefore, according to the embodiment, it is possible to prevent the storage capacity of the cache area 112 from simply decreasing concomitantly with read error occurrence. That is, according to the embodiment, by using two physical blocks in each of which a read error has occurred for multiplexing (duplexing) of data, it is possible to reduce the number of virtual bad blocks to one (half).

In the embodiment, the data D is written in a multiplexed manner to both physical blocks N+1 and N+3. The case where the memory controller 12 (MPU 123) executes operations ROa and Rob of reading the data D from both physical blocks N+1 and N+3 described above is assumed. The probabilities Pea and PEb (0<PEa<1, 0<PEb<1) of occurrence of a read error in the read operations ROa and Rob are high. However, the probability PE (PE=PEa·PEb) of occurrence of a read error in each of both the read operations is lower than PEa and PEb (PE<PEa, PE<PEb).

That is, according to the embodiment, by the multiplexing of the data D using physical blocks N+1 and N+3, it is possible to enhance the probability Ps of success in the read of the data D. Thereby, it is possible to improve the performance (that is, read cache performance) in the read of data from the NAND memory 11 used as the cache memory. In the NAND memory 11, read errors attributable to read disturb occur in proportion to the number of times of read. Accordingly, in the embodiment, a particular effect on such a read error is exhibited. The aforementioned probability Ps is expressed by 1−PE (that is, 1−PEa·PEb).

In the embodiment, the data D is written in a multiplexed manner to two physical blocks (free areas) found from the second free area list 111c. However, the data D may be written in a multiplexed manner to three or more physical blocks. In this case, although the data write performance lowers, and the number of times of update of the cache management table 111a increases, it is possible to further improve the probability of success in the read of the data D.

Here, it is assumed that no read error has occurred in the read of the data D from physical block N+3 (No in block 606). In this case, the MPU 123 advances to block 607. In block 607, the MPU 123 causes the host interface 121 to transfer the data D to the main controller 27 as described previously.

Conversely, if a read error has occurred in the read of the data D from physical block N+3 (Yes in block 606), the MPU 123 advances to block 609 again. In block 609, the MPU 123 adds physical block N+3 to the second free area list 111c again. At this time, no unselected area in which the data D is stored exists (No in block 610). In this case, the MPU 123 advances to block 611.

In block 611, the MPU 123 causes the host IF 121 to return a response (error response) indicative of that an error has occurred in the read of the data D specified by the second read request from the main controller 27 to the main controller 27. Thereby, the MPU 123 terminates the read processing. Further, the MPU 123 executes block 611 even in the case of a cache mis-hit where no data D is stored in the NAND memory 11 (No in block 603).

Now, having sent the second read request corresponding to the first read request to the memory controller 12, the MPU 273 of the main controller 27 starts disk read processing based on the first read request. That is, the MPU 273 controls the driver IC 25 such that the head 22 is positioned on a target track on the disk 21 specified by the start logical address. Further, the MPU 273 causes the head 22 to read the data D in a state where the head 22 is positioned on the target track.

When a completion response is returned to the MPU 273 from the memory controller 12 in the middle of the disk read processing, the MPU 273 forcibly terminates the disk read processing. Conversely, when an error response is returned to the MPU 273 from the memory controller 12 in the middle of the disk read processing, the MPU 273 continues the disk read processing. In this case, the MPU 273 causes the HDC 272 to transfer the data D read by the disk read processing to the host. Further, the MPU 273 sends a write request (more specifically, a write request corresponding to the second write request) used to instruct the memory controller 12 to write the data D read by the disk read processing to the NAND memory 11 to the memory controller 12. The MPU 123 executes the write processing (cache write processing) described previously based on the write request. However, here, the data D is written to the NAND memory 11.

When the error response is returned to the MPU 273 from the memory controller 12, the MPU 273 may start the disk read processing. In this case, although the responsiveness to the first read request from the host lowers, the control of the MPU 273 is simplified.

In the embodiment described above, the table 111a, and lists 111b, 111c, and 111d are stored in the NAND memory 11. However, the table 111a, and lists 111b, 111c, and 111d may be stored in the RAM 125. In this case, there is the possibility of the contents of the table 111a, and contents of the lists 111b, 111c, and 111d being lost owing to a sudden shutdown of the power to the hybrid drive. When such loss occurs, it becomes impossible for the MPU 123 to read the objective data (for example, the data D) from the NAND memory 11. However, the data D is stored also in the disk 21. Accordingly, the data D is read from the disk 21 by the above-mentioned disk read processing. Therefore, although the response performance of the hybrid drive to the first read request from the host temporarily lowers, the main controller 27 can return the data D to the host as a response to the first read request.

In the configuration in which the table 111a, and lists 111b, 111c, and 111d are stored in the RAM 125, the table and lists may be stored in the third area of the disk 21 when the power to the hybrid drive is turned off. Further, in the embodiment, the table 111a, and lists 111b, 111c, and 111d stored in the system area 111 of the NAND memory 11 may be loaded from the NAND memory 11 into the RAM 125 and be used when the power to the hybrid drive is turned on. In this case, the table 111a, and lists 111b, 111c, and 111d stored in the RAM 125 may be saved into the NAND memory 11 when the power to the hybrid drive is turned off, and the old table 111a, and old lists 111b, 111c, and 111d stored in the NAND memory 11 may be invalidated. In such a configuration, the access count information may be registered in the table (cache management table) 111a. In this case, the access counter table 125a becomes unnecessary.

According to the at least one embodiment described above, by effectively utilizing a storage area in which a read error has occurred in the past, the lowering of the substantial storage capacity of a nonvolatile storage medium can be prevented from occurring to the utmost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage apparatus comprising:
a first storage medium which is nonvolatile;
a second storage medium which is nonvolatile, the second storage medium being lower in access speed, and larger in storage capacity than the first storage medium;
a cache controller configured to control the first storage medium as a cache; and
a main controller configured to control the cache controller, and access the second storage medium based on an access request from a host apparatus,
wherein the cache controller is configured to write, in a multiplexed manner, data to be stored in the first storage medium to at least two areas in which deterioration of storage performance has been detected based on a result of access to the first storage medium.

2. The storage apparatus of claim 1, wherein the cache controller is further configured to execute a read operation of reading data requested by the main controller from the at least two areas in sequence, and return successfully read data to the main controller when read of the data written in a multiplexed manner to the at least two areas is requested by the main controller in accordance with a read request from the host apparatus.

3. The storage apparatus of claim 2, wherein the cache controller is further configured to
manage a free area of the first storage medium using first management information; and
search the first management information for an area to be used to write the data requested by the main controller when write is requested by the main controller in accordance with a write request from the host apparatus.

4. The storage apparatus of claim 3, wherein the cache controller is further configured to
manage the areas in which the deterioration has been detected, using second management information;
select a non-multiplexed area in which data is stored in the first storage medium when the search of the area from the first management information has been failed;
write, in a multiplexed manner, the data stored in the selected non-multiplexed area to the at least two areas as the data to be stored; and
add, after the multiplex write, the selected non-multiplexed area to the first management information as a free area.

5. The storage apparatus of claim 4, wherein the cache controller is further configured to
manage a storage position of data written to the first storage medium, and a state of access to the storage position for each area of a predetermined size in the first storage medium; and
select the non-multiplexed area based on the managed access state when the search of the area from the first management information has been failed.

6. A cache controller of a storage apparatus comprising a first storage medium which is nonvolatile, and a second storage medium which is nonvolatile, the second storage medium being lower in access speed, and larger in storage capacity than the first storage medium, the cache controller comprising:
a processor configured to control the first storage medium as a cache;
a first interface controller configured to control signal transmission/reception between a main controller and the processor, the main controller being configured to control the cache controller based on an access request from a host apparatus, and access the second storage medium based on the access request; and
a second interface controller configured to access the first storage medium under the control of the processor,
wherein the processor is configured to write, in a multiplexed manner, data to be stored in the first storage medium to at least two areas in which deterioration of storage performance has been detected based on a result of access to the first storage medium.

7. The cache controller of claim 6, wherein the processor is further configured to execute a read operation of reading data requested by the main controller from the at least two areas in sequence, and return successfully read data to the main controller through the first interface controller when read of the data written in a multiplexed manner to the at least two areas is requested by the main controller in accordance with a read request from the host apparatus.

8. The cache controller of claim 7, wherein the processor is further configured to
manage a free area of the first storage medium using first management information; and
search the first management information for an area to be used to write the data requested by the main controller when write is requested by the main controller in accordance with a write request from the host apparatus.

9. The cache controller of claim 8, wherein the processor is further configured to
manage the areas in which the deterioration has been detected, using second management information;
select a non-multiplexed area in which data is stored in the first storage medium when the search of the area from the first management information has been failed;
write, in a multiplexed manner, the data stored in the selected non-multiplexed area to the at least two areas as the data to be stored; and
add, after the multiplexed write, the selected non-multiplexed area to the first management information as a free area.

10. The cache controller of claim 9, wherein the processor is further configured to
manage a storage position of data written to the first storage medium, and a state of access to the storage position for each area of a predetermined size in the first storage medium; and
select the non-multiplexed area based on the managed access state when the search of the area from the first management information has been failed.

11. A method, of a storage apparatus, for writing data to a first storage medium which is nonvolatile, the storage apparatus comprising the first storage medium, a second storage medium which is nonvolatile, a main controller, and a cache controller, the second storage medium being lower in access speed, and larger in storage capacity than the first storage medium, the main controller being configured to access the second storage medium based on an access request from a host apparatus, and the cache controller being configured to control the first storage medium as a cache under the control of the main controller based on the access request, the method comprising
writing, in a multiplexed manner, data to be stored in the first storage medium to at least two areas in which deterioration of storage performance has been detected based on a result of access to the first storage medium.

12. The method of claim 11, further comprising:
executing a read operation of reading data requested by the main controller from the at least two areas in sequence when read of the data written in a multiplexed manner to the at least two areas is requested by the main controller in accordance with a read request from the host apparatus; and
returning successfully read data to the main controller.

13. The method of claim 12, further comprising:
managing a free area of the first storage medium using first management information; and
searching the first management information for an area to be used to write the data requested by the main controller when write is requested by the main controller in accordance with a write request from the host apparatus.

14. The method of claim 13, further comprising:
managing the areas in which the deterioration has been detected, using second management information;
selecting a non-multiplexed area in which data is stored in the first storage medium when the search of the area from the first management information has been failed;
writing, in a multiplexed manner, the data stored in the selected non-multiplexed area to the at least two areas as the data to be stored; and
adding, after the multiplexed write, the selected non-multiplexed area to the first management information as a free area.

15. The method of claim 14, further comprising:
managing a storage position of data written to the first storage medium, and a state of access to the storage position for each area of a predetermined size in the first storage medium; and
selecting the non-multiplexed area based on the managed access state when the search of the area from the first management information has been failed.
